(19) United States
(12) Patent Application Publication
(10) Pub. No.: US 2024/0234751 A9
(43) Pub. Date: Jul. 11, 2024

(54) CELL STACK AND CELL STACK ASSEMBLY

(71) Applicant: CERES INTELLECTUAL PROPERTY COMPANY LIMITED, West Sussex (GB)

(72) Inventors: Andrew Ballard, West Sussex (GB); Tomasz Domanski, West Sussex (GB); Duncan Albert Wojciech Gawel, West Sussex (GB); Rajan Thandi, West Sussex (GB)

(73) Assignee: CERES INTELLECTUAL PROPERTY COMPANY LIMITED, West Sussex (GB)

(21) Appl. No.: 18/546,691

(22) PCT Filed: Feb. 18, 2022
(86) PCT No.: PCT/GB2022/050451

§ 371 Date: Aug. 16, 2023

(30) Foreign Application Priority Data
Feb. 19, 2021 (GB) 2102404.7

(51) Int. Cl. H01M 8/0247

(52) U.S. Cl. CPC H01M 8/0247; H01M 2008/1293

(57) ABSTRACT

An electrochemical cell stack (12) comprising a plurality of stacked cell units (10), each defining an external perimeter, a housing (58) surrounding the stack (12) to define a volume around the external perimeters, and at least one electrically insulating beam (76), the beam (76) extending generally in a stacking direction of the stacked cell units (10), to extend across a multiple of the cell units (10), and located between the external perimeters thereof and the housing (58), wherein an electrical connection member (54) of the cell stack's current delivery system extends inside the electrically insulating beam (76).

The present invention relates to an improved cell stack and to a cell stack assembly comprising one or more such cell stacks, as well as a method of manufacturing the same. The present invention more specifically relates to stacks of fuel cells or electrolysis cells, generically known as electrochemical cell units, which may be based on various cell chemistries such as solid oxide or PEM, and in particular, it relates to metal supported solid oxide fuel cells (MS-SOFCs) or metal supported solid oxide electrolysis cells (MS-SOECs). The present invention also relates to assemblies comprising such fuel cells or electrolysis cells.

Electrochemical fuel cells use an electrochemical conversion process that oxidises fuel to produce electricity. They are commonly planar in configuration, and are commonly formed into a multi-layer fuel cell unit with internally manifolded fluid passageways between top and bottom layers. Such fuel cell units may be arranged overlying one another in a stack arrangement, for example 10-200 fuel cell units in a stack, with fluid passageways also between the stacked cell units. Other fuel cells may instead use externally manifolded flowpaths for the fuel and oxidant.

Each fuel cell unit operates to generate electricity when in operation.

The technology behind solid oxide fuel cells (SOFCs) is based upon a solid oxide electrolyte that conducts negative oxygen ions from a cathode to an anode located on opposite sides of the electrolyte. For this, a fuel, or reformed fuel, contacts an anode of the fuel cell unit (aka the fuel electrode), and an oxidant, such as air or an oxygen rich fluid, contacts a cathode of the fuel cell unit (aka the air electrode). The fluid passageways inside and between the cell units permit this. There are other forms of electrochemical cell unit too.

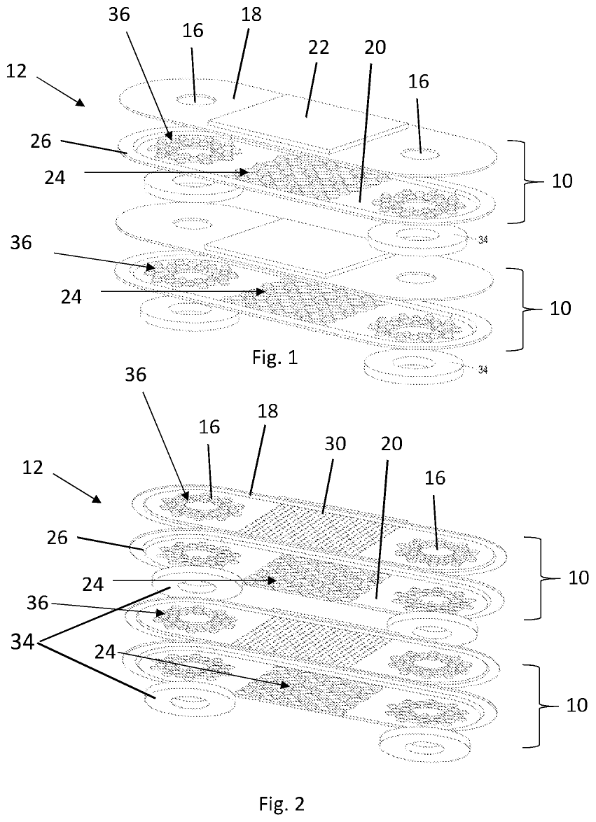

Conventional ceramic-supported (for example such as anode-supported) SOFCs have low mechanical strength and are vulnerable to fracture. Hence, metal-supported SOFCs have been developed which have the active fuel cell component layer supported on a metal substrate. In these metal supported solid oxide fuel cells, the ceramic layers can be very thin since they only perform an electrochemical function, as opposed to also performing a structural strength function. Such stacks incorporating such metal supported SOFC stacks are commonly more robust than ceramic-supported SOFCs, and can generally be made at a lower cost. WO2020/126486 and WO2015/136295 both disclose example prior art arrangements for such metal supported SOFCs, and examples therefrom are shown in FIGS. 1 to 7 of the present application to assist in explaining the operation of the stack. The present invention, however, can apply to all forms of electrochemical cell units.

A solid oxide electrolyser cell (SOEC) is another form of electrochemical cell. It may have the same structure as an SOFC but is essentially that SOFC operating in reverse, or in a regenerative mode, to achieve the electrolysis of water and/or carbon dioxide by using the solid oxide electrolyte to produce hydrogen gas and/or carbon monoxide and oxygen.

The present invention is directed at a stack of repeating electrochemical cell units and may have a structure suitable for use as an electrolyser cell or a fuel cell. For convenience, the electrochemical cell units in a stack will hereinafter be referred to as “cell units”. These may be for electricity generation or for use in a regenerative mode (i.e. including either or both SOEC or SOFC units, or other forms of electrochemical cell units).

Significant challenges in mechanical, electrical and thermal design are encountered when designing cell units and stacks, as the cell units in the stacks, and the stacks themselves, are required to maintain a consistent electrical connectivity internally to ensure no electrical spikes or arcing occurs within the stack. This can be due to the presence of fuel and oxidant fluids in the stack. It is also important for achieving persistent fluid seals both within and between the cell units, and through the stack, for defining and segregating fluid passageways for the fuel and the oxidant in the cell units and the stack as it is important that they don't mix within the stack. The design also needs to allow for consistent manufacturing processes and structural integrity during a prolonged use of the stack assembly, bearing in mind that fuel and/or electrolysis cells in some applications will undergo significant thermal cycling if repeatedly powered up and down, or significant movement, for example, if used in vehicle applications.

According to a first aspect of the present invention there is provided an electrochemical cell stack comprising:
a plurality of stacked cell units, each defining an external perimeter;
a housing surrounding the stack to define a volume around the external perimeters; and
at least one electrically insulating beam, the beam extending generally in a stacking direction of the stacked cell units, to extend across a multiple of the cell units, and located between the external perimeters thereof and the housing, wherein an electrical connection member of the cell stack's current delivery system extends inside the electrically insulating beam.

Examples of electrochemical cell stacks include fuel or electrolysis cell stacks.

This aspect of the present invention helps to ensure that the current collection circuitry is protected from electrical contact with the cell units to minimise the risk of shorting within the cell stack. In this respect it will be noted that the electrical connection member is electrically conductive, as are (usually) the housing and the cell units—particularly when metal supported, and they can create electrical shorting if they ever directly touch one another. Having the electrically insulating beam (i.e. a non-electrically-conductive component) around the electrical connection member prevents such electrical shorting.

In addition, the beam can provide a further beneficial function during assembly of the stack, and thereafter during use of the stack. As the beam is located between the external perimeters of the cell units and the housing, during assembly and thereafter it can be positioned to engage against the external perimeters of at least some of the cell units, thus providing an alignment function for the cell units both during assembly and after assembly—during use.

In some embodiments, the beam or beams can be used to eliminate a need for alignment members during the assembly process, which alignment members have to be removed at a later stage of the assembly process.

In some embodiments there are at least two electrically insulating beams, and at least one of those beams has an (e.g. rigid, conductive, elongate) electrical connection member of the cell stack's current delivery system extending inside it.

In some embodiments each electrical connection member that extends inside one of the electrically insulating beams extends the full length of that beam—i.e. in a stacking direction of the stacked cell units.

In some embodiments the or each beam may be formed of two or more parts, for example an upper part and a lower part. In some embodiments each part extends generally in a stacking direction of the stacked cell units, to extend across a multiple of the cell units, and to be located between the external perimeters thereof and the housing. The electrical connection member of the cell stack's current delivery system may extend inside each part of the electrically insulating beam. In some embodiments each part can be positioned to engage against the external perimeters of at least some of the cell units. In some embodiments, each part provides an alignment function for the cell units both during assembly and after assembly.

In some embodiments the or each beam comprises two parts—an upper part and a lower part, the upper part being stacked on the lower part, with the electrical connection member extending through both parts.

In some embodiments the length of the or each beam is adjustable, for example by the provision of one or more stepped surface, or by the provision of a tapering surface, between adjacent parts thereof, or by the provision of additional parts thereof.

In some embodiments the or each beam is provided with a slot in a part thereof to allow it to be fitted around the electrical connection member to extend the beam after fitting of the electrical connection member though one or more other part of the beam.

In some embodiments the or each beam has one or more cut-away section to increase fluid flow in that area—for example to allow greater airflow to offer greater cooling. The cut-away section may be in a one piece beam or in a multi-part beam, with the cut-away section then being in one or more part of that multi-part beam.

In some embodiments the cell units comprise solid oxide fuel cells (SOFCs).

In some embodiments the cell units comprise solid oxide electrolysis cells (SOECs).

In some embodiments the cell units comprise one or more other suitable type of electrochemical cell.

In some embodiments the cells, and or the cell units, are generally planar.

The cell units may, for example, be electrode or electrolyte supported, or metal supported, in which case—the electrochemically active layers may be provided or coated upon a perforated or porous metal structure.

The cell units may define first fluid passageways internal of the cell units, e.g. between upper and lower plates of each cell unit.

The cell units may define second fluid passageways between adjacent cell units.

The cell units may be flat or planar.

The housing can be a stack enclosure defining a fluid volume containing the stack of cell units. Alternatively the housing may be a skirt of the stack enclosure. The skirt may be welded to top and bottom end plates of the stack enclosure.

The housing or skirt may be associated with only a single stack (which it surrounds) and, moreover, the beam may be associated with only a single stack (extending in the stack direction thereof), rather than between separate stacks.

In some embodiments the electrical connection member extending inside the electrically insulating beam is an electrical connection member dedicated for that stack to deliver current from a collector plate provided for the stack.

In some embodiments a stack may have more than one such dedicated electrical connection member.

In some embodiments the stacked cell units are arranged electrically in series throughout, and a collector plate is provided at each end of that stack.

In some embodiments the stacked cell units are arranged both in series and in parallel, and a collector plate is provided at each pole of the stack.

In some embodiments, electrical connection members in the form or bus bars extend from some or all of the collection plates to one or more end plate of a stack enclosure.

Preferably the end plate (or end plates) is (are) at one end (or both ends) of the cell stack.

In some embodiments the insulating beams—preferably mica or ceramic tubes—extend to at least one of a top or bottom of the stack of cell units, or to an inner surface of an end plate of the stack enclosure.

In some embodiments the beam abuts the external perimeters of at least two of a multiple of the cell units so as to exert a force that resists the movement of the multiple of cell units further towards the beam.

In some embodiments, the force is generated by the housing (or skirt) also engaging with the beam, either directly or indirectly, to wedge or bias the beam against the cell units, or to wedge or bias the beam between the housing and the cell units, so as to exert a constraining or positioning force against the cell units for resisting movement of the cell units relative to the housing and/or the beams.

Preferably the external perimeters of all of the cell units of the multiple of cell units abut the electrically insulating beam.

The electrical connection member extending inside the beam can be a bus bar connected to a connection plate for the stack, or some other component of the cell stack's current delivery system. For example it may comprise a stud or cable connecting to or from the bus bar or collection plate.

In some embodiments the electrical connection member extends beyond the beam to exit out of the housing through the top or bottom of the stack, e.g. through an end plate of the stack enclosure.

In some embodiments, a further conductor connects to the electrical connection member, and that further conductor exiting out of the housing.

Some embodiments have even further additional components for extending the current delivery system out of the housing.

According to a second aspect of the present invention there is provided an electrochemical cell stack comprising:
a plurality of stacked cell units, each defining an external perimeter;
a housing surrounding the stack to enclose a volume around the external perimeters; and
at least two electrically insulating beams each extending across a multiple of the cell units, and each engaging against the external perimeters of at least two of those respective multiple of cell units,
wherein the beams define a line that extends between the two beams, which line defines a lateral line across the respective cell units,
and wherein either or both:
a) the tangents of contact between each beam and the respective ones of the multiple of cell units are co-operative to resist movement of the respective ones of the multiple of cell units both in both lateral directions along that defined lateral line of the cell unit and in at least one longitudinal direction that lies both generally perpendicular to that lateral line and generally planar to the external perimeter of that respective cell unit, or
b) the tangents of contact of each beam with the respective ones of the multiple cell units being co-operative for each beam to resist movement of the respective one of the multiple cell units both in at least one lateral direction along that defined lateral line of the cell unit and in at least one longitudinal direction that lies both generally perpendicular to that lateral line and generally planar to the external perimeter.

By resisting movement of the respective ones of the multiple of cell units in both lateral directions along that defined lateral line of the cell unit, the cell units cannot move to the left or the right relative to a central longitudinal plane of the stack.

By resisting movement of the respective ones of the multiple of cell units in at least one longitudinal direction that lies both generally perpendicular to that lateral line and generally planar to the external perimeter of that respective cell unit, the cell units cannot move forward (or backwards—depending upon which direction is constrained) along that central longitudinal plane of the stack.

By resisting movement of the respective one of the multiple cell units in at least one lateral direction along that defined lateral line of the cell unit, the cell units cannot move to either the left or the right (depending upon which direction is constrained) relative to the central longitudinal plane of the stack.

Such movement restrictions are beneficial as to minimise relative movements of components within the stack reduces the potential for such movements to breach seals between neighbouring components, or for impacts or vibrations applied to the stack to otherwise dislocate elements from their intended positions.

In some embodiments the beams are full height relative to the stack of fuel cells.

In some embodiments an electrical connection member of the cell stack's current delivery system extends inside one or both of the beams.

In some embodiments the beams contact at least 50% of the cell units in the stack of cell units. In other embodiments, they touch all of the multiple thereof. In another embodiment they touch more than 50% of the cell units in the multiple of cell units.

If the cell units don't have perfectly aligned edges throughout the stack thereof, some might not touch the beam.

The line between the beams will typically be a line extending from sectional centres of the beams, or distal-most extremes thereof in the airflow (or oxidant flow) direction through the stack of fuel cells.

Typically the two beams will correspond in shape. In some embodiments they mirror each other across the lateral width of the cells units.

This second aspect of the present invention can likewise have features of the first aspect of the present invention, and vice versa. In particular, an (e.g. rigid, conductive, elongate) electrical connection member of the cell stack's current delivery system may extend inside a beam.

According to a third aspect of the present invention there is also provided an electrochemical cell stack comprising:
a plurality of stacked cell units, each defining an external perimeter;
a housing surrounding the stack to enclose a volume around the external perimeters;
two opposed electrically insulating boards located between the housing and the plurality of stacked cell units, each being against one of two opposing sides of the plurality of stacked cell units; and
at least one electrically insulating beam that extends across multiple cell units within the stack, and engages against the external perimeters of those respective multiple cell units,
wherein the insulating beam also engages against either or both the housing and one of the electrically insulating boards.

Through that engagement of both the cell units and the housing or boards, upon assembly, the components are all automatically correctly aligned in the stack. This can allow any appropriate fluid passageways within the cell units themselves—e.g. for fuel or oxidant flow—to be correctly formed. It also reduces the possibility of electrical shorting between cell units within the stack as their edges are restrained from movement towards each other.

In some embodiments an electrical connection member of the cell stack's current delivery system extends inside one or both of the beams.

In some embodiments there are at least two electrically insulating beams, each extending across a multiple of the cell units.

In some embodiments the second beam engages against the external perimeters of those respective multiple cell units, and against either or both the housing and one of the electrically insulating boards.

In some embodiments each beam engages against external perimeters of a multiple of the cell units, and against either or both the housing and one of the electrically insulating boards.

In some embodiments the beams are each integrally formed with one of the electrically insulating boards. More usually, however, they will be separate components.

Each board that engages edges of the cell units has a cell engaging face that provides that engagement. In some embodiments the beam closest to that cell engaging face of one of the boards has a cell engaging surface that extends distal of that board's cell engaging face—i.e. it extends away therefrom towards the central longitudinal plane of the stack, for example into recesses in the edges of the cell units, or partially across respective ends of the cell units. In a preferred embodiment, the two beams each have a cell engaging surface that extends distal of its closest board's cell engaging face. With these two distal positionings of those cell engaging surfaces of the two beams, the two beams provide a constriction across the width of the cell units between the two beams compared to the width between the two boards. With that constriction, the beams provide a concentration of airflow through a central stream of the second fluid passageway—aligning with the constriction between the beams, and a lesser airflow to the sides of the second fluid passageway—in the spaces either side of the central stream, corresponding to the portion of that second fluid passageway that aligns with the distal extension of the beams, i.e. adjacent the two sides of the cell units against which the boards lie.

In some embodiments the two beams are located at or near a downstream end of the second fluid passageway, or at or near a downstream end of the fluid passageway that carries the oxidant—which is the same end in a co-flow arrangement. The downstream end that carries the oxidant is commonly the hotter end of the cell stack, and having the constriction at least at that end concentrates the oxidant flow (i.e. usually an airflow) at that hotter end to assist with the increased need for fluid flow to affect the required cooling. In other words, the flow density can be increased at that hotter part of the cell stack.

With four beams, they can be located at both ends of the fluid passageways.

Each electrically insulating board may also be in engagement with the inner wall of the housing, although in some embodiments the arrangement may comprise two or more boards between each opposing side of the plurality of stacked, cell units—i.e. stacked boards.

In some embodiments, the electrically insulating boards are located only to two of the sides of the stacked cell units—preferably parallel opposing sides—and more preferably the long sides of the cell units—i.e. the proximal and distal ends of the stacked cell units (relative to the airflow/oxidant flow direction) do not have such electrically insulating boards in contact with the external perimeter of the stacked cell units.

In some embodiments, more than one electrically insulating board is located side by side, or one above the other, in a common plane, against the respective opposing side of the stacked cell units.

The third aspect of the present invention may additionally feature one or more feature of the first or second aspects of the present invention, and vice versa. In particular, an (e.g. rigid, conductive, elongate) electrical connection member of the cell stack's current delivery system may extend inside a beam.

According to a fourth aspect of the present invention there is provided a cell stack assembly comprising a cell stack as defined above, a fuel delivery port connecting to a first fluid passageway within the cell stack, an oxidant delivery port connecting to a second fluid passageway within the cell stack, current collector plates for collecting or delivering electrical current from or to the cell stack, and an electrical connection member for delivering the current out of or into the housing from or to the collector plates.

The fourth aspect of the present invention may additionally feature one or more feature of any one or more of the first, second or third aspects of the present invention, and vice versa.

According to a fifth aspect of the present invention there is provided an electrochemical cell stack assembly comprising:
a stack of cell units, each defining an external perimeter;
a housing surrounding the external perimeters of the stacked cell units to define a volume around the external perimeters, the housing initially comprising at least two separate parts;
at least two electrically insulating beams, one electrically insulating beam assembled between one initially separate part of the housing and the stacked cell units, and a second electrically insulating beam assembled between a second initially separate part of the housing and the stacked cell units, the at least two electrically insulating beams each extending across a multiple of the cell units, and abutting the external perimeters of at least two of the multiple of cell units so as to exert a force that resists movement of the multiple of cell units further towards the beams;
wherein the first and second initially separate parts of the housing clamp the at least two beams against the external perimeters of those at least two of the multiple of cell units upon closing two parts of the housing together.

Typically the two separate parts are initially not connected together.

Preferably the at least two parts of the housing are welded together in that clamping state to retain the clamping force.

The fifth aspect of the present invention may additionally feature one or more feature of any one or more of the first, second, third or fourth aspects of the present invention, and vice versa. In particular, an (e.g. rigid, conductive, elongate) electrical connection member of the cell stack's current delivery system may extend inside a beam.

According to a further aspect of the present invention there is provided an electrochemical cell stack comprising:
a plurality of stacked cell units, each defining an external perimeter; and
at least one electrically insulating beam, the beam extending generally in a stacking direction of the stacked cell units, to extend across a multiple of the cell units, wherein an electrical connection member of the cell stack's current delivery system extends inside the electrically insulating beam;
wherein the or each beam is formed of two or more parts.

According to yet a further aspect of the present invention there is provided an electrochemical cell stack comprising:
a plurality of stacked cell units, each defining an external perimeter; and
at least one electrically insulating beam, the beam extending generally in a stacking direction of the stacked cell units, to extend across a multiple of the cell units, wherein an electrical connection member of the cell stack's current delivery system extends inside the electrically insulating beam;
wherein the or each beam has one or more cut-away section to increase fluid flow in that area. This beam may be in one or more parts.

With these further aspects, which aspects may also be in accordance with any of the preceding aspects, there may be a first part—usually an upper part, and a second part—usually a lower part, for the or each beam. In some embodiments there is a third part. There can even be further parts.

In some embodiments each part extends generally in a stacking direction of the stacked cell units, to extend across a multiple of the cell units, and to be located between the external perimeters thereof and a housing for the stack. The electrical connection member of the cell stack's current delivery system may extend inside each part of the electrically insulating beam. In some embodiments each part can be positioned to engage against the external perimeters of at least some of the cell units. In some embodiments, each part provides an alignment function for the cell units both during assembly and after assembly.

In some embodiments the or each beam comprises two parts—an upper part and a lower part, the upper part being stacked on the lower part, with the electrical connection member extending through both parts.

In some embodiments the length of the or each beam is adjustable, for example by the provision of one or more stepped or castellated surface, or by the provision of a tapering or chamfered surface, between adjacent parts thereof.

In some embodiments one or more part of the or each beam is provided with a slot in its sidewall. This is to allow it to be fitted around the electrical connection member to extend the beam after fitting of the electrical connection member though one or more other part of the beam—e.g. after access to the free end of the electrical connection member is restricted.

In some embodiments the or each beam has one or more cut-away section to increase fluid flow in that area—for example to allow greater airflow to offer greater cooling. The cut-away section may be in a one piece beam or in a multi-part beam, with the cut-away section then being in one or more part of that multi-part beam.

The cell stacks of the present invention, and the cell stack assemblies, may be used in domestic, industrial, commercial or transport/vehicle applications. In one such application there would be provided a fuel cell system comprising an electrochemical cell stack as defined above used in a vehicle application.

According to a sixth aspect of the present invention there is provided a method of assembling an electrochemical cell stack, the method comprising providing:
stacked cell units, each cell unit defining an external perimeter; and
at least one electrically insulating beam, assembled against the stacked cell units such that the electrically insulating beam extends across a multiple of the stacked cell units, and engages against the external perimeters of those respective multiple cell units
the method comprising;
fitting a housing around the stacked cell units and the electrically insulating beams, the housing defining a volume around the external perimeters, the housing being initially in at least two separate parts;
wherein: the first and second initially separate parts of the housing are clamped against the external perimeters of those at least two of the multiple of cell units upon closing two parts of the housing together to exert a force that resists movement of the multiple of cell units further towards the beams and the initially separate parts are then connected or joined together in that clamping state to retain the clamping force by the beam against the external perimeters of those at least two of the multiple cell of cell units.

In some embodiments there are at least two electrically insulating beams;
one electrically insulating beam is assembled between a first initially separate part of the housing and the stacked cell units, and a second of the electrically insulating beams is assembled between a second initially separate part of the housing and the stacked cell units, the at least two electrically insulating beams each extending across a multiple of the cell units, and abutting the external perimeters of at least two of the multiple of cell units so as to exert a force that resists movement of the multiple of cell units further towards the beams; and
the first and second initially separate parts of the housing are clamped against the external perimeters of those at least two of the multiple of cell units upon closing two parts of the housing together to exert a force that resists movement of the multiple of cell units further towards the beams and the initially separate parts are then connected or joined together in that clamping state to retain the clamping force by the beams against the external perimeters of those at least two of the multiple of cell units.

In some embodiments the first and second initially separate parts of the housing are clamped indirectly against the external perimeters of those at least two of the multiple cell of cell units via one or more electrically insulating boards in addition to the or each electrically insulated beam.

In some embodiments the beam or beams engages against the external perimeters in recesses in those external perimeters.

The fuel or electrolysis cell stack of the method of the sixth aspect of the present invention may be a fuel or electrolysis cell stack of any one of the first to fifth aspects of the present invention, and may comprise any one or more of the preferred or optional features of those first to fifth aspects of the present invention. In particular, an (e.g. rigid, conductive, elongate) electrical connection member of the cell stack's current delivery system may extend inside a beam.

In some embodiments the beams are circular beams.

In some embodiments the beams are tubes.

In some embodiments a bus bar of the cell stack extends inside at least one of the beams, for example in the centre of the beam.

In some embodiments there are two bus bars in the stack and each one is in one of the beams.

In some embodiments the beams comprise mica.

In some embodiments two opposed electrically insulating boards are located between the housing and the plurality of stacked cell units, each against one of two opposing sides of the plurality of stacked cell units, the insulating beams being additional to the electrically insulating boards.

In some embodiments the beams also each contact one of the electrically insulating boards.

In some embodiments the beams also contact the housing.

In some embodiments the beams extend the full height of the stack.

In some embodiments each beam contacts each cell unit.

In some embodiments each beam defines a barrier for fluid flow entering or exiting the second fluid passageway. This can assist by blocking or reducing fluid flow around the outside of the beam between the external perimeter and the housing, and by directing the flow of fluid through a more central stream of the second fluid passageway.

In some embodiments each beam defines a barrier for fluid flow entering or exiting the second fluid passageway whereby there is a concentration of airflow through a central stream of the second fluid passageway and a lesser airflow to the sides of the second fluid passageway, adjacent the straight sides of the cell units. This can be beneficial in providing more flow at the hotter parts of the cells in some embodiments.

In some embodiments the external perimeters comprise two straight sides and shaped ends.

In some embodiments the beams are located at one of the shaped ends.

In some embodiments the beams sit in concavities or recesses formed in otherwise straight sides of the external perimeters, the concavities or recesses preferably having a configuration complimentary in shape to that of the beam, i.e. the part of the beam that fits therein or thereagainst.

In some embodiments the cell unit is generally rectangular.

In some embodiments there is a beam in each long side of the rectangle.

In some embodiments there is a beam in or adjacent to, two of the corners of the rectangle.

In some embodiments the two corners are adjacent corners.

In some embodiments the two corners are adjacent corners at the ends of one of the short sides of the rectangle.

In some embodiments the two corners are at a downstream end of the second fluid passageways, or an airflow/oxidant flow fluid passageway, of the stacked cell units—that passageway defining a longitudinal direction that lies both perpendicular to a lateral line across the fluid passageway and generally planar to the external perimeter of at least one of the cell units.

In some embodiments a flow direction for fluid through a first fluid passageway, or a fuel flow fluid passageway, corresponds to the flow direction for fluid through the second fluid passageway—i.e. the stacked cell units use a co-flow arrangement for the fluids through the stacked cell units. Alternatively there can be a contraflow arrangement where the flow direction for fluid through a second fluid passageway opposes the direction of flow for fluid through a first fluid passageway. In other arrangements, the flows may be at other angles relative to one another—e.g. 90 degrees from one another.

In some embodiments there are three or four beams.

In some embodiments each cell unit has two straight sides that each accommodate two of the beams.

In some embodiments the cell units have two or four corners and each corner has one of the beams.

In some embodiments the different parts of the external perimeters respectively each define a concavity or recess such that each beam sits in that concavity or recess.

In some embodiments each corner has a concavity or recess for accommodating one of the beams.

In some embodiments the concavity or recess is at a centre of a side of each cell unit.

In some embodiments the concavities or recesses wrap around at least a 90 degree segment of its respective beam.

In some embodiments the concavities or recesses wrap around at least a 180 degree segment of its respective beam.

In some embodiments the concavities or recesses have curved walls.

In some embodiments the concavities or recesses are recesses with two or more straight wall portions against which the beams press, the straight wall portions being angled with respect to one another in each concavity or recess.

In some embodiments the beams extend perpendicularly transverse to the cell units, i.e. parallel to the longitudinal or stack-height direction of the stack.

In some embodiments the external perimeters of all of the cell units align with one another all the way around the perimeters.

In some embodiments the housing has a bottom and a top, and a skirt surrounding the external perimeters of the cell units.

In some embodiments the skirt is formed of at least two parts, joined together at their seams—for example by welding.

In some embodiments the housing has separately provided top and bottom components and the skirt is joined to those top and bottom components—for example by welding.

In some embodiments the stacked cell units each comprise a separator plate and a metal support plate, the separator plate and the metal support plate overlying one another;
wherein:
one or more first fluid passageway extends through the cell units, between respective separator plates and metal support plates of each cell unit;
the stacked cell units comprise second fluid passageways extending between adjacent cell units; and
the first fluid passageways and the second fluid passageways are for distribution of fuel and oxidant through the stack.

In some embodiments there are active and non-active cell units in the stack.

In some embodiments each active cell unit has one or more cell chemistry layer provided over a porous or perforated region of a metal plate of the cell unit.

In some embodiments the cell chemistry layer comprises multiple layers, including an anode layer, an electrolyte layer and a cathode layer.

In some embodiments at least one fluid port is provided in each of cell units, the respective fluid ports of adjacent cell units being aligned and in communication with a first fluid passageway in each cell unit.

In some embodiments the cell units comprise separator plates with shaped outward projections to partially separate adjacent cell units for defining a second fluid passageway between adjacent cell units.

In some embodiments the outward projections of a first cell unit engage at their ends against an outer surface of a cell chemistry layer of an adjacent cell unit.

In some embodiments the cell units comprise a metal support plate with shaped port features formed around a port thereof, which shaped port features extend towards a separator plate of the cell unit, and elements of the shaped port features are spaced from one another to define fluid pathways between the elements from the port to enable passage of fluid from the port to a first fluid passageway within the cell unit, between the metal support plate and the separator plate.

In some embodiments each cell unit is planar.

In some embodiments each cell unit contains at least one recess on at least one perimeter edge, these recesses being aligned across the width or length of the cell unit.

In some embodiments the recesses are configured in shape, at least partially, to match and abut the facing part of the adjacent electrically insulating beam or tube.

In some embodiments the electrically insulating beam is disposed between and in contact with both the housing and the external perimeters of the cell units so as to prevent or close a fluid flow path between the electrically insulating beams and the housing or skirt thereof.

In some embodiments two of the electrically insulating beams are located adjacent to an internally manifolded fluid port, or a fluid outflow port, such that where the beams contact the external perimeter of the cell units, they serve to define and limit or constrict the fluid flow path to the internally manifolded fluid port, or the fluid outflow port.

In some embodiments, each cell unit contains at least one recess on at least one peripheral edge in which one of the electrically insulating beams is assembled, wherein the at least one recess has a shape reciprocal to that part of the respective one of the electrically insulating beams that is assembled in the recess (the respective recesses of adjacent recesses being aligned to define a recessed channel extending in the stack direction).

According to a further aspect of the present invention there is provided a method of assembling an electrochemical cell stack, the method comprising providing:
cell units, each cell unit defining an external perimeter; and
at least one electrically insulating beam, for assembly against the cell units such that the electrically insulating beam extends across a multiple of the stacked cell units, and to engage against the external perimeters of those respective multiple cell units, with an electrical connection member of the cell stack's current delivery system extending inside the electrically insulating beam;
the method comprising:
fitting a first part of the electrically insulating beam over the electrical connection member, stacking the cell units against the first part of the electrically insulating beam, and then fitting a second part of the electrically insulating beam over the electrical connection member and the first part of the electrically insulating beam.

This method may be combined with any one or more of the other aspects of the present invention.

In some embodiments the or each beam is formed from just two separate parts. In some embodiments the beam is formed from three or more separate parts.

In some embodiments the or each beam has one or more cut-away section to increase fluid flow in that area within stack.

In some embodiments the length of the or each beam is adjustable, for example by the provision of one or more stepped or castellated surface, or by the provision of a tapering surface, between adjacent parts thereof.

With this aspect of the present invention the method may comprise the first and second parts of the beam being initially installed over the respective electrical connection member in a reduced length configuration, a connection between a top of the respective electrical connection member can then be made to an upper electrical connector before then extending the beam to a more extended length. If instead initially installed at the more extended length, access to the top of the electrical connection member might be blocked by an upper collector plate at the top of the stack of cell units, or by the top of the beam, or both.

In some embodiments the length of the beam is adjusted to fit it up against an underside of an upper collector plate.

In some embodiments one or more part of the or each beam is provided with a slot in its sidewall. This is to allow it to be fitted around the electrical connection member to extend the beam after fitting of the electrical connection member though one or more other part of the beam—e.g. after access to the free end of the electrical connection member is restricted.

In some embodiments the or each beam has one or more cut-away section to increase fluid flow in that area within stack.

It will be appreciated by a skilled person that each feature of each aspect can likewise be utilised by each of the other aspects—either in isolation or in combination with other features of each aspect.

These and other features of the present invention will now be described in further detail, purely by way of various examples, with reference to the accompanying drawings, in which:

FIGS. 1 and 2 show exploded views of two forms of prior art cell unit—two cell units in each figure arranged in a vertical stack;

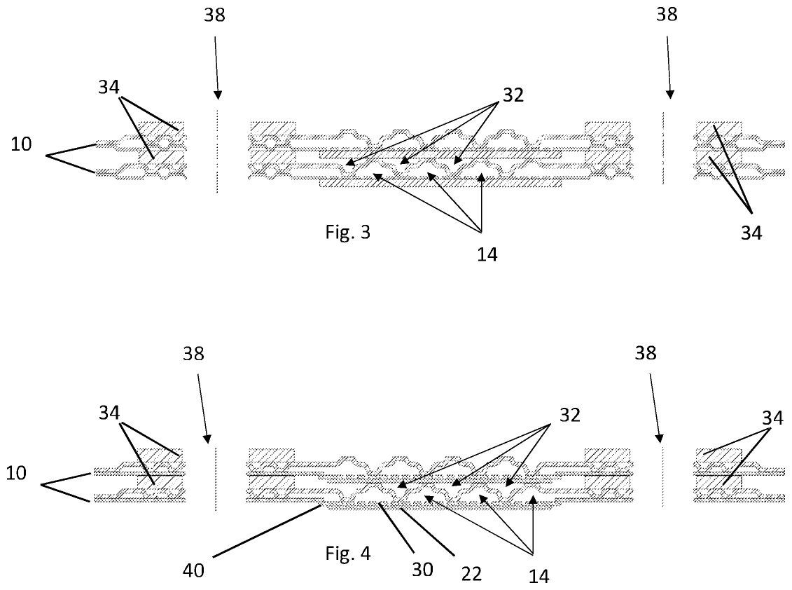

FIG. 3 shows the stack of FIG. 2 in assembled form;

FIG. 4 shows a further variant of the cell unit, similar to FIG. 1 but with a separate metal cell component and metal support plate;

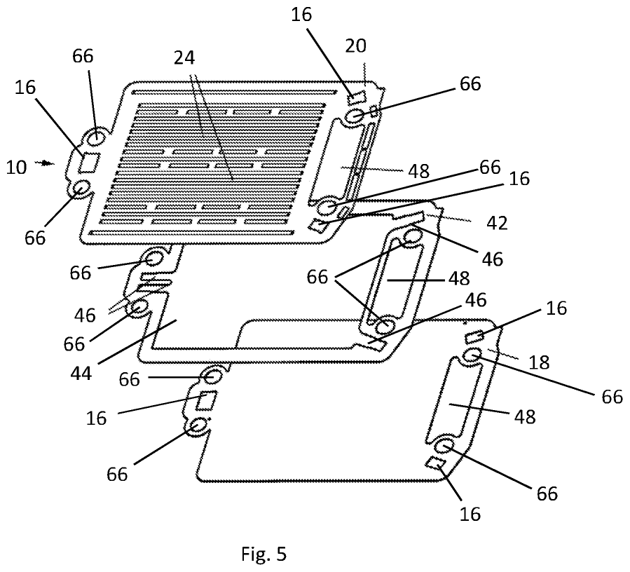

FIG. 5 shows an exploded view of an alternative prior art cell unit;

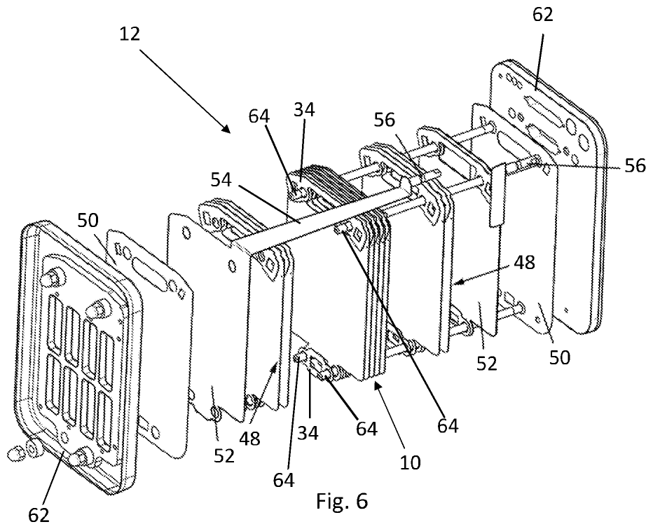

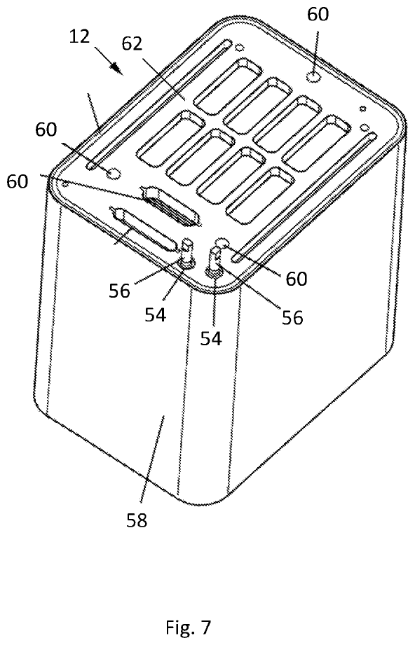

FIGS. 6 and 7 show a prior art cell stack assembly in exploded and assembled form, respectively, albeit with some of the cell units removed for clarity in FIG. 6;

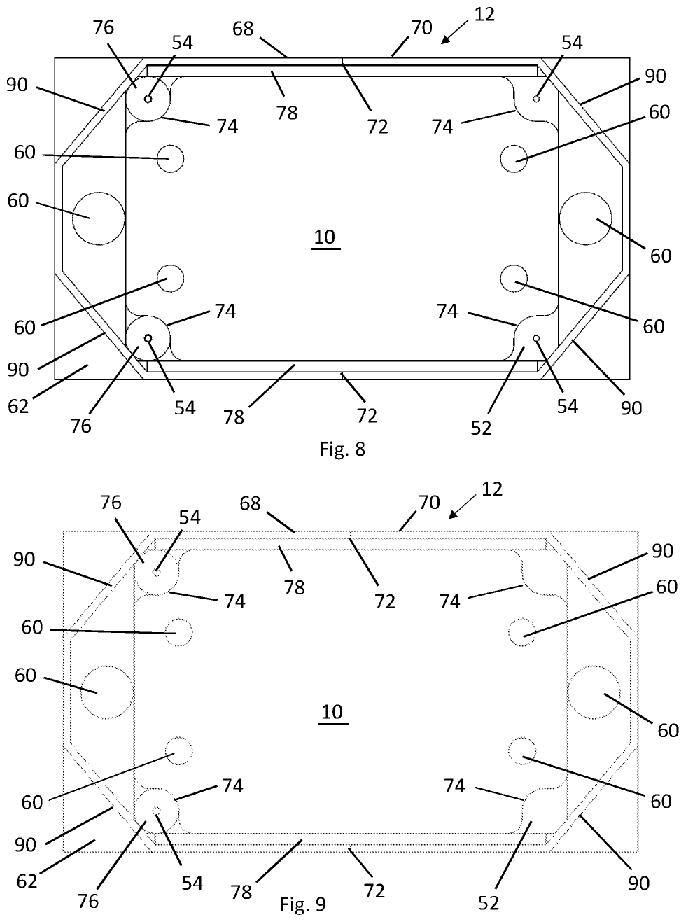

FIG. 8 shows a top plan view of a first embodiment of the present invention, with four bus bars extending upward from a collector plate 52 and two electrically insulating beams;

FIG. 9 shows a second embodiment of the present invention, similar to the first, but with just two bus bars extending upward from the collector plate;

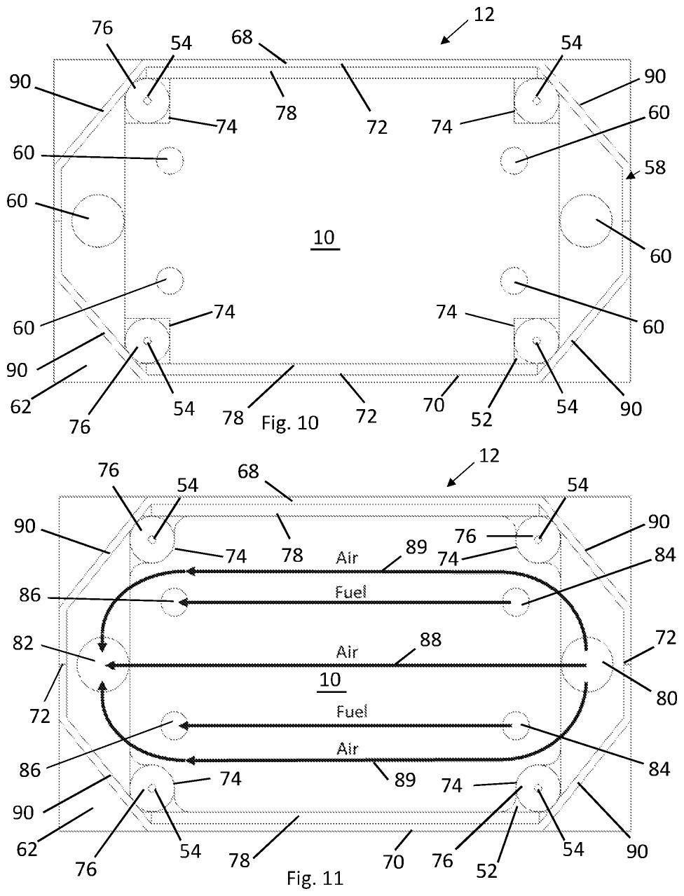

FIG. 10 shows a variant of the cell stack of FIG. 8 with reshaped corners for the cell units thereof and four electrically insulating beams—one in each corner;

FIG. 11 shows a further variant of the cell stack of FIG. 8, albeit with four electrically insulating beams—one in each corner, and showing a co-flow fuel and oxidant (air) flow configuration;

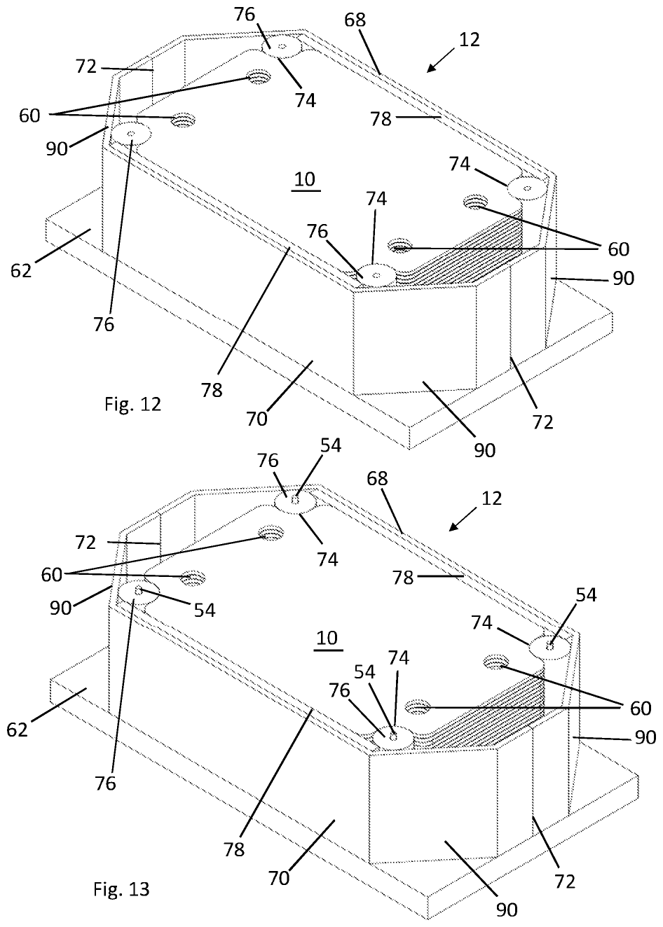

FIG. 12 shows a perspective view of the cell stack of FIG. 11 with the four bus bars not present;

FIG. 13 shows the cell stack of FIG. 12 with the four bus bars present;

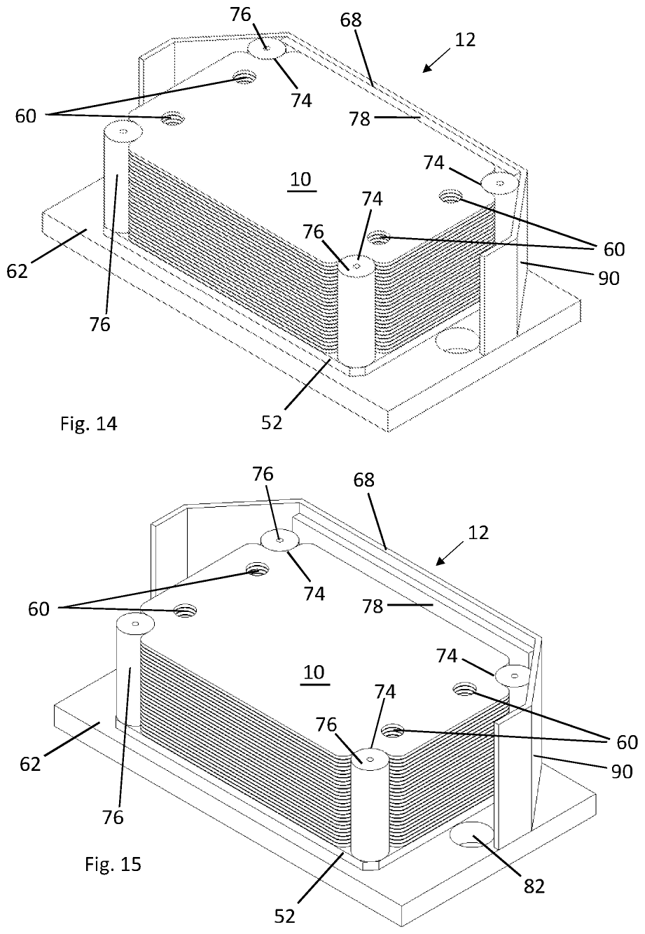

FIG. 14 shows the cell stack of FIG. 12 with a part of the housing thereof removed;

FIGS. 15, 16 and 17 show in part cut-away view various assembly steps for assembling the housing around the stack of cell units in the cell stack of FIG. 12.

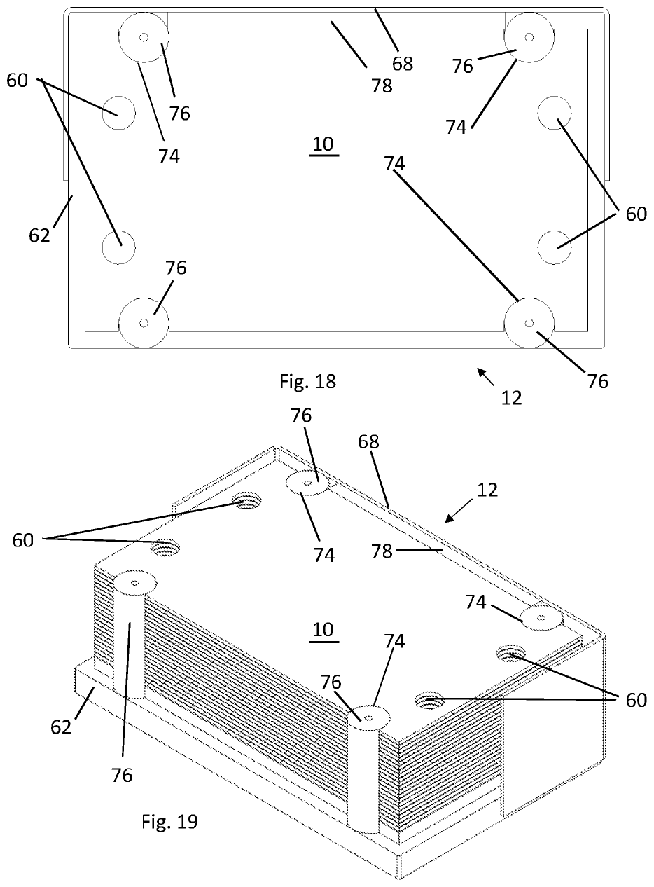

FIGS. 18 and 19 show a further variant of the present invention, again with part of the housing removed therefrom;

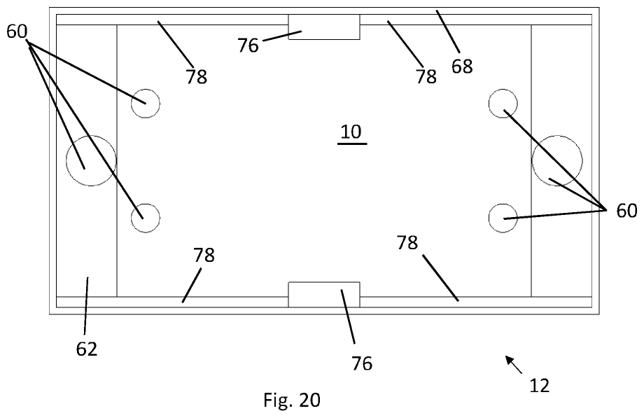

FIG. 20 shows yet another further variant of the present invention with a one piece housing;

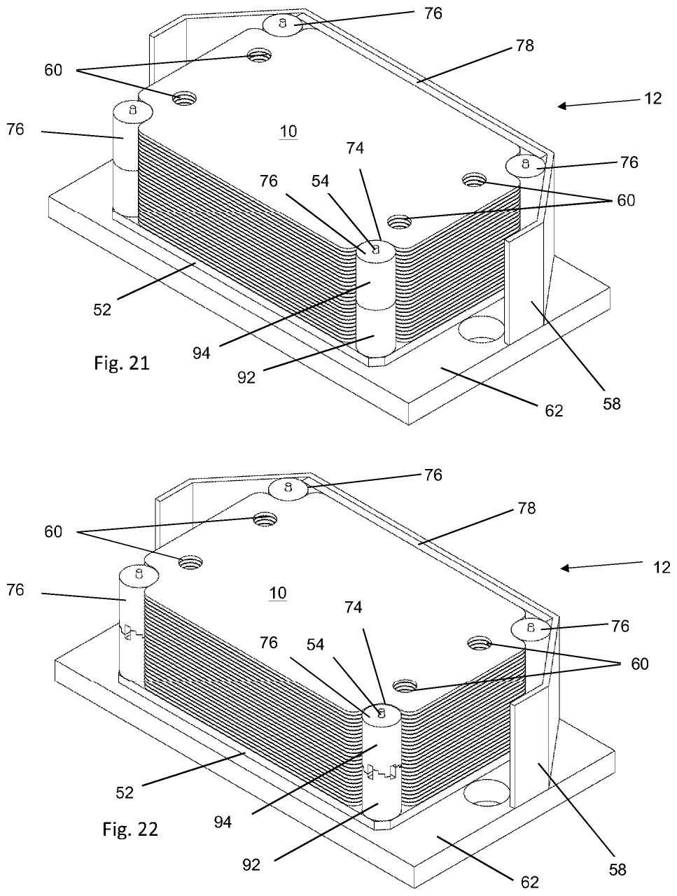

FIG. 21 shows a further variant of the present invention with four two-piece beams;

FIG. 22 shows a further variant of the present invention with four two-piece beams, each having stepped surfaces for varying the length of the beam;

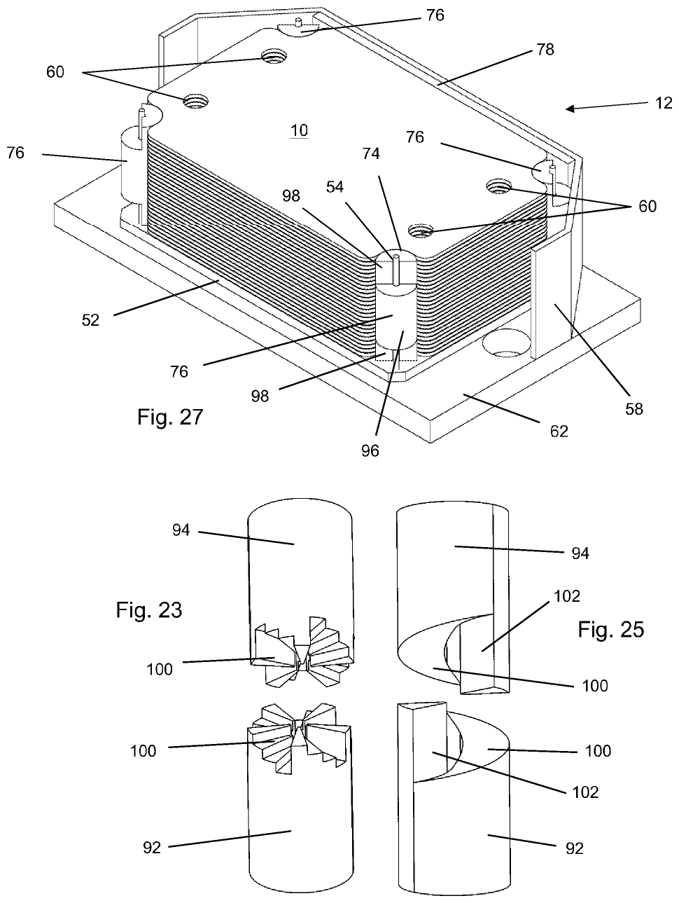

FIG. 23 shows the two pieces of the beam from FIG. 22 in more detail;

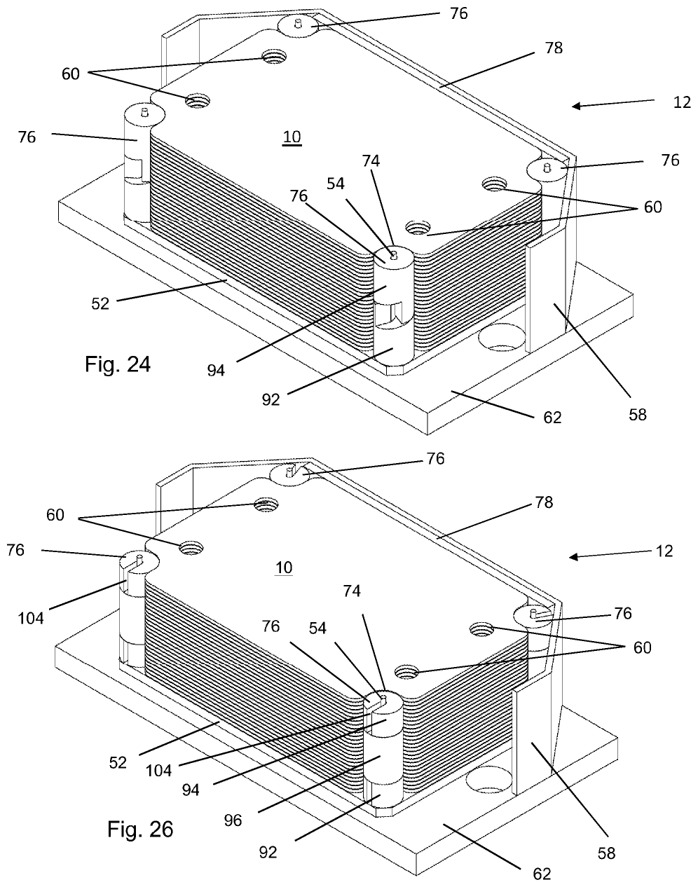

FIG. 24 shows a further variant of the present invention with four two-piece beams, each having tapering surfaces for varying the length of the beam;

FIG. 25 shows the two pieces of the beam from FIG. 24 in more detail;

FIG. 26 shows a further variant of the present invention with four three-piece beams, with a central first part and two outer parts, each outer part having a slot for allowing its insertion onto the beam after fitting the central first part into the stack around the electrical connection member;

FIG. 27 shows a further variant of the present invention with four beams, the ends of the beams having cut-away sections for increasing fluid flow in that area—for example to allow greater airflow to offer greater cooling.

Referring first of all to FIG. 1 there is shown a prior art configuration of fuel cell units 10—two shown in exploded form, arranged in a stack 12—for illustrating a possible internal structure for a fuel cell unit 12 for allowing a fluid passageway to be formed inside the centre of the fuel cell unit 10, and accessible via ports 16 at each end thereof. The details of this form of fuel cell unit 10 are discussed in depth in WO2020/126486, the entire contents of which are incorporated herein by way of reference. In brief, however, each of these fuel cell units 10 in this example comprises two plates or layers—in the form of a top metal support plate 18 and a bottom separator plate 20. The metal support plate 18 has thereon an active fuel cell component layer 22 and the separator plate 20 has numerous central projections and recesses 24 and further projections and recesses, 36 stamped therein, along with a raised rim 26 for joining the separator plate to the underside of the metal support plate 18.

FIG. 2 shows a variant of the fuel cell units of FIG. 1 where additional further projections and recesses 36 are also provided on the metal support plate 18 around ports 16 thereof—for facing the further projections and recesses around the ports 16 in the separator plate 20. Likewise a raised rim is provided in the metal support plate to overlie the similar rim in the separator plate.

As can be seen by comparing FIGS. 1 and 2, the projections in FIG. 1 are recesses in FIG. 2, and vice versa, as FIG. 2 looks at the underside of the plates, whereas FIG. 1 shows the upper side. Hence the terms are interchangeable.

FIG. 2 also shows that the area of the underside of the metal support plate that underlies the fuel cell component later 22 comprises an array of perforations 30. These perforations allow both sides of the fuel cell component layer to be accessible even though it is formed on the metal support plate, and are present likewise in the example of FIG. 1.

These exploded view illustrations, along with FIGS. 3 and 4, are useful to help explain possible internal arrangements for the cell unit of the present invention, as the present invention can utilise a similar cell unit structure, although as discussed below, in typical embodiments of the present invention the external perimeter's profile will differ. Further additional or fewer ports 16 may be provided, depending upon the fluid flow requirements of the stack.

In each active fuel cell unit of the stack, the fuel cell component layer may be an electrochemically active layer deposited on, and supported by, the metal support plate 18, which is typically a metal (usually stainless steel) foil. The electrochemically active layer comprises each of an anode layer, an electrolyte layer and a cathode layer, as is known in the art. Additional layers can also be included as known in the art, such as cover layers or control layers.

Referring to FIG. 3, the fuel cell units 10 of FIG. 2 are shown in assembled form, with the metal support plate 18 and the separator plate 20 of each fuel cell unit 10 now joined together around their edges. As can be seen in this sectional view, the central projections and recesses 24 in the separator plate 20 maintain a space between the two plates of each unit to define a first fluid passageway 14, and also a second space between the adjacent fuel cell units 10 that defines a second fluid passageway 32. The gaskets 34 also maintain the spacing at the ends of the fuel cell units 10 and overlie the further projections or recesses 36 around the ports 16 in both the separator plate and the metal support plate. The gaskets 34 are annular so that their central openings also overlie the ports 16. A “chimney” or passageway 38 is thus formed through the stack, which passageway is sealed from the second fluid passageway 32 between adjacent fuel cell units 10 by the gaskets 34, but which is open to the first fluid passageway 14 internal of the fuel cell units. Fluid can thus be fed via the ports 16 through and out of the first fluid passageway. Fluid through the second fluid passageway instead circulates around the outside of the fuel cell units, as will be discussed in further detail below.

In FIG. 4 the further projections and recesses 36 are only provided in the separator plate, as in FIG. 1, which in some embodiments may require a longer/deeper projection/recess to be stamped as there are no longer two to add together. However, in this embodiment, this instead allows for an additional thickness of the support plate 18 which is present as the fuel cell component layer is instead deposited on a further support plate 40, which is joined to that metal support plate 18 in a further step, as discussed further in WO2020/126486. That further support plate is instead provided with the array of perforations on its underside, as can be seen in FIG. 4.

Whereas FIGS. 1 to 4 are from WO2020/126486, FIGS. 5 to 7 are from WO2015/136295. These show further possible prior art fuel cell arrangements. Stacks of metal-supported SOFCs are again provided, and the operation is largely the same. However, in place of the further projections and recesses in the separator plate, and in the case of FIGS. 2 and 3 the metal support plate, this example instead uses a spacer plate 42 between the metal support plate 18 and the separator plate 20. Further, the separator plate 20 uses beams and grooves 24 instead of projections and recesses 24.

In this example, the spacer plate 42 has a central opening 44 that defines the first fluid passageway 14 within the cell unit (once assembled) which central opening 44 connects to the ports 16 in the separator plate 20 and the metal support plate 18 via venting passages 46. Further, the three plates 18, 20 42 also have a further port 48 for venting into (or out of) the second fluid passageway 32 between adjacent fuel cell units 10, as discussed in WO2015/136295, the entire contents of which are incorporated herein by way of reference.

FIG. 6 shows a plurality of the fuel cell units 10 of FIG. 5 arranged in a fuel cell stack 12. Dummy cells 48 are also shown—which might not have all the necessary layers to make the fuel cell component layer active, or which might be absent the perforations, but which may otherwise appear to be complete for a consistent design configuration, as also known in the art. Further, collector plates 52 are shown for collecting the electrical charge generated by the stack of active fuel cell units 10.

To best capture that charge, the fuel cell units are usually arranged electrically in series through the stack, and the collector plates are at each end of that series stack, although fuel cell units within a stack can also (or instead) comprise units arranged in parallel, as also known in the art, with the collector plates then being appropriately positioned at the poles of those parallel stacks.

The collector plates 52 can be connected to, or are integrally formed with (as shown for the left hand collector plate in FIG. 8) one or more bus bar 54 and/or terminal 56 to carry the current therefrom to outside of the stack assembly. Such collector plates 52, bus bars and terminals can be seen in FIGS. 6 and 8, and the terminals 56 can be seen to extend external of the stack assembly once the stack assembly is fully assembled in FIG. 7.

In assembling the stack 12, a plurality of fuel cell units 10 are used, the fuel cell units 10 being stacked upon one another between two end plates 62, with the current collector plates 52 being at the poles of the stack of fuel cell units, and insulation plates 50 between the collector plates 52 and the end plates 62.

In FIG. 6, the solid oxide fuel cell units are held in compression in the assembled stack with the use of multiple tie-bars 64—four shown—running between the two end plates 62, through guide holes 66 (see FIG. 5) in the three plates 18, 20, 42 of the fuel cell units 10. As can be seen in FIG. 7, nuts at the ends of the tie bars 64 provide that compression. In other examples, the compression can be pre-loaded and retained by welding a skirt around the cells—to the end plates. This latter approach is used in the examples of the present invention in FIG. 9 onwards, but compression bolts might instead be used, although due to the proximity of the tie-bars to the edges of the guide holes (i.e. to the edges of the metal components which define the guide holes in the at least one fuel cell stack), careful design consideration is required as there is a risk of short circuit between the tie-bars and the stack when the components expand at high temperatures in potentially mixed atmosphere involving steam, reacted and unreacted hydrocarbons and air, whereby the restraining skirt is preferred.

The preceding examples of prior art fuel cells have all been described as examples of one possible type of cell unit that can utilise features and the advantages of the present invention in a cell stack or cell stack assembly. It will be appreciated too by a skilled person in the art that yet further shapes of cell unit, designs of bus bar/electrical take-off, and shapes of housing can also be used. In the following discussion of example embodiments of the present invention, such further designs will be discussed.

Referring next to FIG. 8, an embodiment of the present invention is shown. In this cell stack assembly 12, the cell stack comprises a plurality of cell units 10 arranged in a stack inside a housing 58, which in this embodiment is a skirt formed in two halves 68, 70, which join together on the long sides of the cell units 10. That join can be a weld at a weld line 72 that, as shown in FIG. 8, is central to the long side of the stack. It need not be central, but central is convenient for symmetry or for ease of manufacture and assembly—so that the two halves can easily be interchanged during assembly. In the alternative version in FIG. 10, the weld line 72 can be at the short ends of the cell unit 10—as per FIG. 10 it is again shown central to that side, which again is optional but preferred for symmetry, or for ease of manufacture and assembly.

The cell units 10 are generally rectangular, albeit with shaped corners 74, which corners 74 can accommodate an electrically insulating beam such that the beam becomes located between the corners 74 and the housing or skirt 58. In these examples, the electrically insulating beams 76 take the form of a circular shaped or tubular shaped beam, such as the pipe or tube as shown—with a central void. In the preferred examples they will be made of mica, although other electrically insulating materials, including many ceramics, can also be used; preferably non-frangible electrically insulating materials are used. In FIG. 8 only two of the corners feature a beam 76. They are both located at a short end of the stack—in this embodiment that being the fluid outlet end of the stack, as indicated by FIG. 11. In some embodiments just one beam 76 might be provided. In others three or four, or more, beams may be provided. FIG. 10 shows four.

In the example of FIG. 8, four bus bars or electrical connection columns 54 are shown, each in electrical contact with a collector plate 52 at the base of the stacked cell units 10. In this example, they are all a common pole and thus all collect the current from that pole. A further collector plate may be provided at the opposite pole, and further bus bars or direct connectors may be used.

These bus bars and any connectors connected thereto allow the current generated by stacked cell units 10 to be collected and distributed external of the stack—distal from the collector plates, similar to in the stack of FIG. 6. Although four bus bars 54 are shown in this example, it would be possible for just one bus bar to be provided, or two (as per FIG. 9) or for any desired number to be provided, or for the bus bars to be replaced by other forms of electrical connection member or other electrical terminal forms.

In FIG. 8, two of the bus bars 54 are threaded through a central aperture in the two beams 76, such that they are surrounded by the beams, thus insulating them from the cell units and the housing. As the bus bars are conductive—usually stainless steel, and since the housing/skirt and the cell units (being metal supported in this embodiment), are likewise primarily made of steel, having the bus bars insulated therefrom provides an advantage as the components can be packed into the housing more compactly.

Referring next to FIG. 9, just two bus bars are provided. Likewise, as in FIG. 8, two beams 76 are provided. In this embodiment the bus bars 54 are both positioned within the beams 76.

In the example of FIG. 9, the electrically insulating beams 76 are provided at two corners 74 of the stack. The other two corners 74 are absent such a beam. As shown each beam is specific for its stack, and in engagement therewith along substantially all of its length (if not all of its length).

In these embodiments, the housing, where it faces these beams 76, is chamfered. As such, the long sides of the housing join to the short sides of the housing by the angled chamfer 90, such that the housing 68, 70 bears against the beams 76 with a net force pointing diagonally across the cell units 10. This helps to maintain the cell units 10 in their correct positions and avoids them being dislocated when the stack 12 experiences vibrations or other shocks—such as during use or transport.

Along the long sides of the cell units 10 there are also provided electrically insulating boards 78. In FIG. 9, as with FIGS. 8, and 10 to 17, these boards 78 extend along the long sides of the cell units 10, contacting at their ends against the start of the chamfers 90. In other examples they extend only part way along the long side of the housing 68, 70. For example there can be multiple boards 78 along each long side. For example, as shown in FIG. 20, there may be multiple boards 78 separated by one or more beam 76. As in FIG. 20, this can be a single beam 76 in the centre of the side.

It is to be noted that in that alternative embodiment of FIG. 20, the beams 76 have a rectangular rather than circular cross-section, although other shapes will be possible too, as readily understood by a skilled person.

Returning to FIG. 9, the shaped corners 74 of the cell units 10 are shown to comprise curved shapes with convex roundings either side of a concave rounding, the latter being shaped to follow the neighbouring profile of the beam 76 that sits within it. In this embodiment the curved shapes match and align vertically on every cell unit in the stack. By following or matching the shape of the beam in this manner, multiple points of contact (or a long, singular, continuous, line of contact) between the beam 76 and the corner 74 of the cell unit 10 (indeed, in a preferred arrangement for every cell unit 10) can be achieved. In particular it is preferred for the beam to closely abut and engage the cell units. This reduces the point loading on the cell units 10 and helps to grip or otherwise control the cell unit (e.g. through that diagonal loading mentioned above) to resist movement thereof during operation of the stack assembly. In FIG. 9, the convex rounding follows the circumference of the round beam—through a segment of around 90 degrees. In FIG. 19, on the other hand, it follows around approximately 180 degrees—i.e. a semicircle of the beam. This latter arrangement does not produce a net diagonal retention force, but instead, by wrapping sufficiently around the beam it retains against longitudinal movements in both directions (forwards or backwards), in addition to a lateral retention (towards the beam).

An alternative configuration is shown in FIG. 10 in which the corners 74 instead comprise two perpendicular sides—i.e. a square or rectangular cut-out. A square or rectangular beam might thus be used for matching that shape, although in this embodiment instead the beam 76 still maintains its circular (tubular) section. In this alternative arrangement, the beam 76 still has multiple (two) points of contact with the corner/recess 74. Therefore there are two tangential lines of contact between the corners 74 and the beams 76, which still provide a net diagonal force to the cell units 10. From these the cell unit still is gripped by the beams to resist movement thereof during use—both lateral and longitudinal movements are resisted.

Referring then to FIG. 20, again a rectangular recess is provided—this time central to the two sides, and a rectangular beam is instead used. Again therefore the cell unit 10 is gripped by the beams 76 to resist movement thereof during use—both lateral and longitudinal movements are resisted. However, it now, like in FIG. 19, wraps sufficiently around the beam such that it retains against longitudinal movements in both directions (forwards or backwards), in addition to a lateral retention (towards the beam).

A skilled person will also understand that a multitude of different shapes for the recesses at the corners 74, or elsewhere where the recess is provided, and likewise the shapes for the beams 76, would also be suitable when looking to fit the beam 76 in a recess in a corner or side of a cell unit 10 between that cell unit and the housing 58.

Furthermore, the beams 76 need not be in the corners or central to the sides, but may be anywhere along the length of the sides of the cell units 10. FIGS. 18 and 19 show the beam 76 positioned near the corners, and FIG. 20 shows the beams at the central part of the sides. The beams 76 thus may be provided anywhere along the sides of the cell unit 10.

It should be noted though that in FIG. 9, where there are only 2 beams, they are preferably at the downstream end of the cell units—relative to the fluid flow direction through the stacked cell units (see FIG. 10 for that flow direction).

Likewise, from FIGS. 10 to 19, it can be seen that instead of just two beams 76, in many preferred embodiments there would be four, two on each side, at or near each end of the cell units 10.

Fluid ports 60 are also shown in FIGS. 8 to 20. In the examples of FIGS. 8 to 17, there are two fluid ports in the end regions of the cell units 10, giving a total of four fluid ports in the cell units 10, whereas in an end plate 62 on which the cell units 10 are stacked (separated therefrom by a collector plate 52 and an unseen insulator plate 50 (see FIG. 6 for an example)), singular fluid ports 60 are provided at each end of the cells units 10. These allow fuel and air/oxidant circulation through the stack 12.

In FIG. 11, for a fuel cell, the fluid ports 60 in the end plates 62 are ports for oxidant flow, whereas the two pairs of fluid ports 60 towards the ends of the cell units 10 are instead fuel ports. However, depending on the configuration of the fuel cell's active electrochemical component layer, these may be reversed to ensure the fuel and the oxidant contact the appropriate one of the cathode or anode of the cell units.

Referring next to FIG. 11, a further embodiment is shown. It is similar to that of FIG. 10, with four beams 76, but instead of the squared recesses in the corners 74, the rounded corners from FIG. 9 are used.

In FIG. 11, fuel flow and air flow (oxidant flow) for a fuel cell mode of operation is schematically shown. As can be seen, the two fluid ports 60 in the end plates 62 (hereinafter an input airflow port 80 and an output airflow port 82) allow air or oxidant to flow into the volume defined by the housing 68, 70 at one end of the cell units 10, for circulating up into the volume and through the cell units 10 between adjacent cell units 10, and then down and out through the output airflow port 82. This flow direction defines a central, longitudinal, flow line 88 from a first end of the cell units to the far ends of the cell units 10. Side flow paths 89 for the air are also shown, which pass nearer the beams, and closer to the sides of the cell units 10. In practice, there will be multiple flow paths through the stacked cell units 10, and they may be straight or convoluted, dependent upon the design of cell units—particularly any projections or recesses, bars or troughs, in the separator plates of the cell units—see FIGS. 1 to 5 for various potential different forms of projections/bars/grooves/recesses that define the flow paths. Other designs will also be apparent to a skilled person, as known in the art.

With that flow direction for the air or oxidant, it can be seen that in FIG. 9, where there are only two electrically insulating beams 76, they are preferentially located at the outflow end of the cell units 10 (at least with respect to the air/oxidant flow). This is the preferred end for the beams 76 as the airflow will tend to push the cell units 10 towards that outflow end and since that end it typically the hot end of the stack when co-flow is being used for the fuel and oxidant. Thus, by having the beams 76 at that far end, with the contact points between the corners 74 and the beams 76 being such as to have a net angled return force pointing at least partially towards the inflow end, the beams will resist such pushing of the cell units. The cell units 10 thus can be resisted from moving with the airflow by the beams 76. The electrically insulating boards, on the other hand, only rest on the sides, and thus do not angle a retention force to counter such a pushing of the cell units, whereby over time the cell units 10 would be able to slide relative to the boards 78 and thus ultimately come out of contact with those side boards 78.

Still referring to FIG. 11, the fuel flow in this embodiment is shown to be flowing in the same direction as the air/oxidant flow, but this flow will instead be between the layers of the individual cell units, and thus inside the cell units 10. This is thus a co-flow arrangement in this example. For that purpose, the pairs of fluid ports 60 at each end of the cell units 10 comprise a pair of input fuel ports 84 and a pair of output fuel ports 86, each located towards opposing ends of the cell units 10—numbered as such in FIG. 11.

As discussed with respect to FIGS. 1 to 7, the air and the fuel pass through or between the cell units in a manner such that they do not mix, but such that they both can flow over the appropriately facing layer of the electrochemically active layers of the cell units for enabling the desired function of the cell stack assembly to occur—where metal supported, the metal support plate can be perforated or porous for allowing that interaction of the fuel with the electrochemically active later, as shown in FIGS. 2, 3 and 4.

It can also be observed from FIG. 11 that the airflow will pass between opposing beams 76 at the far end of the cell units 10, whereat the airflow is constricted between the two beams 76 compared to the area preceding those beams—as signified by the curved airflow lines 89 in FIG. 11. That constriction ensures a more concentrated airflow between those beams 76 compared to the wider space before them. This is an advantageous feature as the hottest end of the cell units is at the fuel and air outlet end in a co-flow arrangement. That constriction, and thus the increased airflow density, will have an increased cooling effect, thus helping to control the temperature at that outflow end of the cell units. This is a particular advantage in a co-flow arrangement, but can also be beneficial in a counterflow arrangement as the air will heat up as it crosses across the cell units 10, thus needing the increased airflow density to offer the same amount of cooling.

Referring next to FIG. 12, a near fully assembled cell stack is shown. In FIG. 12, a plurality of stacked cell units 10 are shown arranged with an electrically insulating beam at each corner 74, as per FIG. 11. There is an electrically insulating board 78 extending down each of the two long sides thereof. Furthermore, the two halves 68, 70 of the housing 58 are fitted around the stacked cell units. In this embodiment it can be seen that the two halves 68, 70 of the housing 58 are positioned to squeeze the ends of the electrically insulating boards 78 against the beams 76, and also to squeeze directly against the beams 76. This provides a net clamping force against the beams 76 to force them into and against the recessed corners 74 of the cell units 10—i.e. with both lateral and longitudinal force components relative to the central flow line 88 (see FIG. 11). This bi-directional clamping provides a retention force for the stack of cell units 10 for holding the stack of cell units 10 such that the individual cell units 10 in the stack thereof are maintained fixed in the lateral direction, and also resisted from forwards longitudinal movements. Further, as there are also beams at the input end of the cell units, the cell units also cannot move rearwardly. The cell units thus are clamped or retained in line, and locked against individual relative movements, thus ensuring external forces applied to the stack assembly are less likely to disrupt or otherwise dislocate the cell units, thus maintaining the efficacy of the seals between the layers thereof (the seals being as known in the art—usually by way of electrically insulating gaskets—typically mica gaskets).

As explained in respect of FIGS. 1 to 7, gaskets will typically be positioned between the cell units 10 for manifolding the ports together to produce passages for the fluids through the stack (just fuel in the examples of FIGS. 1 to 4 and 8 to 20, but potentially oxidant too, as in FIGS. 5 to 7).

With the present invention, therefore, relative disturbance between the cell units 10 is avoided, thus maintaining the integrity of those fluid passages, as a loss of integrity would be highly undesirable, given the flammable and potentially explosive result of mixing the fuel with the oxidant at the usual operating temperatures of these cell units.

Referring next to FIG. 13, the arrangement of FIG. 12 is again shown, but now with four bus bars 54 also being shown—extending through the four beams from a collector plate 52 (not shown—but see FIG. 14). These allow collected current to be delivered out to terminals in a top plate (not shown—but see FIG. 7 for a similar arrangement with two terminals).

Referring then to FIG. 14, the arrangement in FIG. 12 is again shown albeit now with one part 70 of the housing, and one of the electrically insulating boards 78, removed. This shows an electrical collector plate 52 underneath the stacked cell units 10 can be seen. Between that collector plate and the lower end plate 62, a further electrical insulator plate 50 can be provided to insulate the end plate 62 from the collector plate, similar to that shown in FIG. 6.

The removal of the second part 70 of the housing also allows the oxidant outflow port 82 in the lower end plate 62 to be seen. As shown, the electrical collector plate 52 does not extend over the oxidant ports 80, 82. Neither does the electrical insulator plate, although in some examples the electrical insulator plate 50 might do so, and if it was to do so, a corresponding port therein can be provided so that the port remains open to the inner volume of the housing—at the ends of the cell units 10.

Referring next to FIGS. 15, 16 and 17, various steps in the assembly process of a cell stack assembly are shown. These are preferred steps in line with a sixth aspect of the present invention. FIGS. 14 to 16 are partial cutaway views of the stack assembly of FIG. 13 as the beams 76 are cut away to be shorter, and fewer cell units 10 are stacked. This is to help visualise the electrically insulating board 78 lying at the back thereof.

As shown in FIG. 15, a stack of cell units 10 are stacked on the bottom end plate 62 with a first insulator plate 50, an electrical collector plate 52 and four electrically insulated beams 76. The four beams 76 are located in the four corners of the stacked cell units.

To hold the two beams at the back (as shown) of the stacked cell units 10, the first electrically insulating board 78 is fitted against the rears of those two beams 76 along the far long side of the cell units 10 and the first housing half 68 holds them in place.

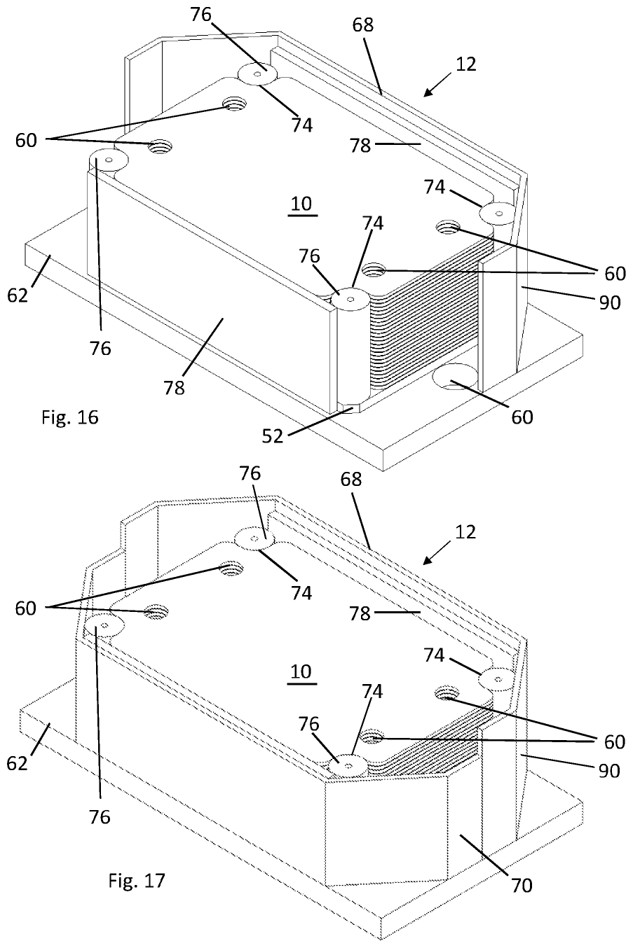

FIG. 16 then shows a second electrically insulating board 78 being positioned against the two closest beams 76 (as seen) and the closest (as seen) long edge of the cell units 10.

FIG. 17 then shows the second half 70 of the housing fitted against the second board 78 and the two closest beams 76 (as seen) to clamp the assembled components together.

Finally, the two halves 68, 70 of the housing 58—in this embodiment a skirt—can be welded or otherwise joined together in that clamped state—herein along pairs of weld lines 72 at each end, which in this example are provided at the short ends of the cell stack.

With the housing or skirt being provided in two halves, it is a simple process to assemble the cell units 10, with the beams and the boards, and to clamp the assembled components together before welding the skirt together, thus retaining the compression force across the beams and cell units. That compression force thus then holds the cell units in their desired relative positions, thus maintaining the integrity of the fluid columns formed therein by the fluid ports and the gaskets between the ports on respective cell units, as seen in, for example, FIGS. 3, 4 and 6.

Referring next to FIGS. 18 and 19, an alternative arrangement is shown, wherein the beams 76 are instead spaced from the corners. The housing 58 is again shown to be in two halves 68, 70, with at present only the first half 68 being shown. To complete the assembly of this stack assembly 12, the second electrically insulating board 78 will need to be fitted—to mirror with the first one 68 that is already shown, and then the second half 70 of the housing 58 would be installed to compress or clamp across the cell units—between the beams 76.

In this embodiment, rather than having the housing compressed both directly and indirectly against the beams, instead it only compresses directly against the beams—the housing 58 does not compress the beams 76 through the boards 78. The boards 78 instead compress only against the sides of the cell units 10. However, the beams 76 still compress in multiple directions against the cell units due to the shape of the recess in the cell units 10—in this example it matching the shape of the facing wall of the beams. However, other shapes for the recesses and beams are also within the scope of the claimed invention, as signified by FIGS. 10 and 20 in which square or rectangular recesses are provided, and in which different beam shapes are provided.

Referring next to FIG. 20, the housing can be seen to be one piece—a sleeve to fit over the components in one go. It might be flexed to fit thereover, thus then still offering a retaining bias against the beams. It again encompasses the beams 76 and the boards 78 on the two long sides of the cell units 10.

Referring next to FIG. 21, a further embodiment of the present invention is shown. In this embodiment, which is largely similar to that of FIGS. 11 to 17, the beams 76 again have a bus bar 54 extending through each of them and they each bear against corners 74 of the fuel cell units 10—here there is one beam 76 in each corner 74 of the stack of cell units 10. Further, the bus bars 54 each connect to and extend upwards from a collector plate 52 at the underside of the stack of cell units 10. However, the beams, instead of being one piece, are each made of two parts—a first or lower part 92 and a second or upper part 94 stacked on top of the first part 92.

In this embodiment the two parts are identical—in the form of tubes or cylinders with the bus bar 54 extending through the central hole.

During assembly, four bus bars 54 can be welded or otherwise electrically connected to the collector plate 52, which is itself stacked on an end plate 62 of the cell stack assembly 12.

The cell units 10 can then be started to be stacked onto the collector plate 52, with the four first parts 92 being located over the bus bars 54 to align the stack of cell units 10. Once the stack approaches the tops of the first parts 92, the second parts can then be installed onto the bus bars, before then completing the stack of cell units 10 within the space between the four second parts 94 of the beams 76. Finally an upper collector plate (nor shown), and upper end plate (not shown), the electrically insulated boards 78 (one shown) and the housing 58 (one half shown) can be fitted to enclose the stack of cell units 10.

In some embodiments—particularly for taller stacks, more than two parts may be provided.

Referring next to FIG. 22, a further modification is shown. In this embodiment the two parts 92, 94 of the beams 76 are provided to have an adjustable length. This can allow the same two parts to be used for a variety of different stack heights. FIG. 23 shows these two parts in more detail. FIG. 24 shows another form for the parts 92, 94 of the beams 76 for providing an adjustable length for the beams 76, with the parts 92, 94 being shown in more detail in FIG. 25.

In FIGS. 22 and 23, the beam's length is adjustable by virtue of the provision of stepped or castellated ends 100 for the two parts 92, 94, which stepped or castellated ends 100 face each other in the middle of the beams 76. These stepped or castellated ends 100 have risers and flats that can interface with facing risers and flats on the opposing part, and due to the possibility to rotate one part relative to the other about the axis defined by the central aperture (e.g. rotating it around the bus bar 54) different risers and flats can engage each other, with a resulting variability of the length of the stacked parts 92, 94.

During assembly, the stacked parts 92, 94 might initially be installed over each respective bus bar 54 at a reduced length. This can provide access to the top of the bus bars 54 for welding or otherwise electrically connecting the tops of the bus bars 54 to upper electrical connectors (not shown). If instead at full length, access to the tops of the bus bars might be blocked by the upper collector plate or the top of the beam 76, or both. Then, once the top of the bus bar 54 is electrically connected to the upper electrical connectors (not shown), the length of the beam 76 can be adjusted to fit up against the underside of the upper collector plate.

Referring instead to FIGS. 24 and 25, an alternative form of beam 76 is shown—again with an adjustable length, but this time with a more infinitely variable length between a maximum and a minimum length, rather than pre-defined step changes provided by the risers and flats. For this purpose the facing ends 100 of the two parts 92, 94 each have a chamfered or angled/sloping surface 100 and a stop member 102. By rotation of the two parts 92, 94, relative to one another about the central axis of the two parts (i.e. about the bus bar 54) the length of the beam 76 can again be varied, providing the same benefits as above. The stop members provide a defined limit for the length variation as the stops 102 on each end 100 will interact against each other at the extremes of length variation.

In each of these two variants for an adjustable beam length, the length might be locked after installation, for example by use of a thermal paste or adhesive or by the provision of a keying feature.

Referring next to FIG. 26, an alternative approach for providing access to the underside of the upper collection plate is provided—e.g. for allowing the ends of the bus bars 54 to be more easily connected to upper electrical connectors. In this embodiment, the upper part 94 is a slotted component—being largely tubular as before, but with a slot 104 extending from its central aperture to its sidewall, the slot 104 having a width wide enough to allow it to be installed over the bus bar 54 without access to the free end of the bus bar 54. With this arrangement, the first part (and here a separate middle part 96) can be first installed over the bus bar 54 with the cell units 10 stacked therebetween, and further the stack can continue up to the top of the stack, with the upper collector plate being then installed (and the upper electrical connectors) before then fitting the upper part 94 of the beams 76—by fitting them over the bus bars 54 using the slot 104 therein to permit this. The upper parts 94 can then be rotated to point the slots 104 away from the corners 74 of the cell units 10 so that they won't come loose.

In this embodiment, the first part 92 is also shown to be a slotted part as it might also want to be removed (or installed later on versus the middle part 96), e.g. for access to (or for servicing of) the connection of the bus bars 54 to the lower collection plate 52.

In some embodiments, this slotted part arrangement may also feature the stepped surfaces or the chamfered surfaces of the previous embodiments.

Referring next to FIG. 27, a further alternative configuration for the beams 76 is shown. In this embodiment, the beams are shown as one piece beams, although they may be made of more than one piece as discussed above. However, in this embodiment the top of the beam has a cut-away part 98—as shown to form a semicircle half at the top. This semicircle bears against the corner 74 of the cell units 10 at the top of the stack, but has its flat face facing outwards to provide flow channels around the outside of the beams 76 at the top of the stack. Such flow provides an additional route for airflow into the top of the stack (for flowing between the cell units) rather than just the gap between the beams at each end of the stack. This increased airflow can improve heat management at the top of the stack, which its where in the stack that it is commonly hotter, versus the bottom or middle of the stack.

In this embodiment, for symmetry of construction (thus making the components less costly to make), the first part 92 of the beams are also featuring a cut-away 98. However, that lower part 92 need not have the cut-away 98 if such further flow thereat is not required.

The middle part 96 in this embodiment is shown to be fully tubular, without a cut-away, although a cut-away can be provided if desired for further cooling the middle section of the stack.

In place of a cutaway forming a semi-circular profile, other forms of cut-away would also achieve a similar additional flow route. For example, part of the beam with the cut-away 98 may be of a concentric tube construction where part of an outer tube is cut away. With such a structure, the bus bar 54 can remain insulated around its circumference even at the cut-away area, which will help prevent contaminants in the air (or dust) from having easy access to the bus bar.

In these alternative embodiments, the beam is still provided with a straight final surface for facing towards the corners 74 of the cell units 10 to allow the beams to still function as alignment guides for the stack of cell units 10. This straight final face, which may be rounded as part (a segment) of the tube, is rotated into engagement with the corner 74 of the cell units 10.

It is preferred that the parts 92, 94, 96 of the beam are formed of mica tube. However, as the stepped ends 100, the chamfered ends 100 and stop 102, and the slot 104 will create smaller details on the beam, with a reduced structural integrity for the shape thereof, it may be preferred to make one or more of the parts 92, 94, 96 of the beam instead out of a ceramic material—one with a more suitable structural strength.

As will be apparent to a skilled person, various structural shapes for the cell units have been described herein—from generally oval in FIGS. 1 to 4 to generally rectangular in FIGS. 5 to 20. The present invention, however, can also use many other shapes of cell unit and be applicable to many electrochemical cell chemistry types. Indeed, the skilled person will appreciate that the shape of the cell unit can be varied widely whilst still utilising the electrically insulating beams 76 of the present invention. The present invention has therefore been described above purely by way of example, and modifications in detail may be made to the invention within the scope of the claims as appended hereto.

1-40. (canceled)

41. An electrochemical cell stack comprising:
a plurality of stacked cell units, each defining an external perimeter;
a housing surrounding the stack to define or enclose a volume around the external perimeters;
two opposed electrically insulating boards located between the housing and the plurality of stacked cell units, each being against one of two opposing sides of the plurality of stacked cell units; and
at least one electrically insulating beam that extends across multiple cell units within the stack, and engages against the external perimeters of those respective multiple cell units,
wherein:
the electrically insulating beam also engages against either or both the housing and one of the electrically insulating boards;
the electrically insulating beam extends generally in a stacking direction of the stacked cell units; and
the electrically insulating beam is located between the external perimeters of the cell units and the housing.

42. The cell stack of claim 41, comprising:
at least two electrically insulating beams each extending across a multiple of the cell units, and each engaging against the external perimeters of at least two of those respective multiple of cell units,
wherein the beams define a line that extends between the two beams, which line defines a lateral line across the respective cell units,
and wherein either or both:
a) the tangents of contact between each beam and the respective ones of the multiple of cell units are co-operative to resist movement of the respective ones of the multiple of cell units both in both lateral directions along that defined lateral line of the cell unit and in at least one longitudinal direction that lies both generally perpendicular to that lateral line and generally planar to the external perimeter of that respective cell unit; or
b) the tangents of contact of each beam with the respective ones of the multiple cell units being co-operative for each beam to resist movement of the respective one of the multiple cell units both in at least one lateral direction along that defined lateral line of the cell unit and in at least one longitudinal direction that lies both generally perpendicular to that lateral line and generally planar to the external perimeter.

43. The cell stack of claim 41, wherein the or each board that engages edges of the cell units has a cell engaging face that provides that engagement, the beam closest to that cell engaging face of one of the boards having a cell engaging surface that extends distal of that board's cell engaging face.

44. The cell stack of claim 43, wherein there are two beams and each has a cell engaging surface that extends distal of its closest board's cell engaging face, the two beams providing a constriction across the width of the cell units between the two beams compared to the width between the two boards.

45. The cell stack of claim 41, wherein each electrically insulating board is also in engagement with the inner wall of the housing.

46. The cell stack of claim 41, wherein two or more boards are provided between each opposing side of the plurality of stacked cell units and the housing.

47. The cell stack of claim 41, wherein the electrically insulating boards are located to just two of the sides of the stacked cell units.

48. The cell stack of claim 41, wherein more than one electrically insulating board is located side by side, or one above the other, in a common plane, against each of two respective opposing sides of the stacked cell units.

49. The cell stack of claim 41, wherein the or each beam is formed of two or more parts.

50. The cell stack of claim 41, wherein a length of the or each beam is adjustable.

51. The cell stack of claim 41, wherein the or each beam has one or more cut-away section to increase fluid flow in that area.

52. The cell stack claim 41, wherein the at least one beam defines a barrier for fluid flow entering or exiting the stacked cell units, blocking or reducing fluid flow around the outside of the beam between the external perimeter of the cell units and the housing, and to direct the flow of fluid through or towards a central stream through the stacked cell units.

53. The cell stack of claim 41, wherein the at least one beam defines a barrier for fluid flow entering or exiting the stacked cell units, whereby there is a concentration of airflow through a central stream through the stacked cell units and a lesser airflow to the sides of the central stream, adjacent the sides of the cell units.

54. The cell stack of claim 41, wherein the at least one beam sits in concavities or recesses formed in the external perimeters of the cell units.

55. The cell stack of claim 41, wherein the housing comprises a skirt around the cell units and the skirt is formed of at least two parts, joined together at their seams.

56. An electrochemical cell stack assembly comprising:
a stack of cell units, each defining an external perimeter;
a housing surrounding the external perimeters of the stacked cell units to define a volume around the external perimeters, the housing initially comprising at least two separate parts;
at least one electrically insulating beam assembled between one initially separate part of the housing and the stacked cell units, the electrically insulating beam extending across a multiple of the cell units, and abutting the external perimeters of at least two of the multiple of cell units so as to exert a force that resists movement of the multiple of cell units further towards the beam;
wherein the first and second initially separate parts of the housing clamp or engage the at least one beam against the external perimeters of those at least two of the multiple of cell units upon closing two parts of the housing together.

57. A method of assembling an electrochemical cell stack, the method comprising providing:
stacked cell units, each cell unit defining an external perimeter; and
at least two electrically insulating beam, assembled against the stacked cell units such that each electrically insulating beam extends across a multiple of the stacked cell units, and engages against the external perimeters of those respective multiple cell units
the method comprising;
fitting a housing around the stacked cell units and the electrically insulating beam, the housing defining a volume around the external perimeters, the housing being initially in at least two separate parts;
wherein:
the first and second initially separate parts of the housing are clamped against the external perimeters of those at least two of the multiple of cell units upon closing two parts of the housing together to exert a force that resists movement of the multiple of cell units further towards the beams and the initially separate parts are then connected or joined together in that clamping state to retain the clamping force by the beam against the external perimeters of those at least two of the multiple cell of cell units.

58. The method of claim 57, wherein there are at least two electrically insulating beams;
one electrically insulating beam is assembled between a first initially separate part of the housing and the stacked cell units, and a second of the electrically insulating beams is assembled between a second initially separate part of the housing and the stacked cell units, the at least two electrically insulating beams each extending across a multiple of the cell units, and abutting the external perimeters of at least two of the multiple of cell units so as to exert a force that resists movement of the multiple of cell units further towards the beams; and
the first and second initially separate parts of the housing are clamped against the external perimeters of those at least two of the multiple of cell units upon closing two parts of the housing together to exert a force that resists movement of the multiple of cell units further towards the beams and the initially separate parts are then connected or joined together in that clamping state to retain the clamping force by the beams against the external perimeters of those at least two of the multiple of cell units.

59. The method of claim 57, wherein the first and second initially separate parts of the housing are clamped indirectly against the external perimeters of those at least two of the multiple cell of cell units via one or more electrically insulating boards in addition to the or each electrically insulated beam.

60. The method of claim 57, wherein the beam or beams engages against the external perimeters in recesses in those external perimeters.
